(19) United States
(12) Patent Application Publication
(10) Pub. No.: US 2004/0165625 A1
(43) Pub. Date: Aug. 26, 2004

(54) Semiconductor laser device and method for holding laser crystal in semiconductor laser device

(76) Inventors: Masayuki Momiuchi, Tokyo-to (JP); Taizo Eno, Tokyo-to (JP); Yoshiaki Goto, Tokyo-to (JP)

Correspondence Address: Kevin S. Lemack, Nields & Lemack, Suite 7, 176 E. Main Street, Westboro, MA, 01581, US

(21) Appl. No.: 10/771,491

(22) Filed: Feb. 4, 2004

(30) Foreign Application Priority Data
Feb. 21, 2003 (JP) JP2003-044932

(51) Int. Cl. H01S 3/04

(52) U.S. Cl. 372/34

(57) ABSTRACT

A semiconductor laser device, comprising a laser crystal, a holder for holding the laser crystal, and a filling material with a low melting point interposed between the laser crystal and the holder.

### BACKGROUND OF THE INVENTION

The present invention relates to a semiconductor laser device and particularly to the improvement of a structure for holding a laser crystal.

An LD-pumped solid-state laser is known, which uses a laser crystal to amplify and emit a laser beam from a semiconductor laser.

Referring to FIG. 4, description will be given below on general features of an LD-pumped solid-state laser.

In FIG. 4, reference numeral 1 denotes a light emitter such as a single laser diode or a plurality of laser diodes, and 2 is an optical system for converging a laser beam or laser beams from the light emitter 1 and for entering the laser beams to a laser crystal 3. On an end surface of the laser crystal 3 closer to the optical system 2, a dielectric reflection film 4 is formed. An output mirror 5 is arranged at a position opposite to the laser crystal 3, and a resonator is provided between the output mirror 5 and the dielectric reflection film 4.

The light emitter 1, the optical system 2, and the laser crystal 3 are fixed on a holder 6, which also serves as a heat sink. As the laser crystal, Nd:YAG (yttrium aluminum garnet) or Nd:YVO₄ is used, for instance.

A laser beam emitted from the light emitter 1 passes through the optical system 2 as an excitation light and enters the laser crystal 3. The laser beam is then pumped between the dielectric reflection film 4 and the output mirror 5, and the laser beam is amplified and projected.

Description will be given below on a structure for holding a laser crystal 8 referring to FIG. 5.

In case the laser crystal 8 is Nd:YVO₄, the laser crystal 8 is cut out in form of a rod with a square cross-section.

A holding groove 9 in rectangular shape is formed on the holder 9, and the laser crystal 8 is placed in the holding groove 9. A crystal holding piece 11 stretching over the holding groove 9 is mounted on the holder 6. The crystal holding piece 11 has a convex portion 11a, which can be engaged with the holding groove 9. The convex portion 11a presses the laser crystal 8 to the holding groove 9 and fixes it on an optical axis of the optical system 2. The holder 6 is provided with a cooling device such as a Peltier element (not shown).

When the excitation light is projected to the laser crystal 8, the laser crystal 8 is excited, and a laser beam is oscillated. At the excitation, a part of energy of the excitation light absorbed to the laser crystal 8 is accumulated in the laser crystal 8 without contributing to the oscillation of the laser beam. This causes the difference in temperature distribution within the crystal.

FIG. 6 schematically illustrates the difference in temperature distribution and heat flow within the laser crystal 8.

In FIG. 6, a right end surface of the laser crystal 8 is an incident end surface of the excitation light. Each of curves 13a, 13b, 13c, 13d, 13e, and 13f shown in the figure as superimposed on an optical axis 12 indicates a curve of temperature distribution. Arrows 14a, 14b, 14c, 14d, 14e and 14f shown as superimposed on the optical axis 12 represent flows of heat.

Heat is locally accumulated on the incident end surface of the laser crystal 8, and this causes wide temperature distribution. Heat in the laser crystal 8 is migrated due to thermal conduction within the laser crystal 8 and also due to heat transfer from the laser crystal 8 to the holder 6. Temperature distribution becomes smaller toward an exit end surface (left end surface of the laser crystal 8 in FIG. 6).

As another structure for holding the laser crystal, the structure described in the specification of U.S. Pat. No. 6,347,109 is known.

The higher the output of the semiconductor laser device is, the more the temperature is increased at the incident end surface, and the more the difference in temperature distribution is further increased. Thermal strain is increased due to the difference in temperature distribution, and cracking may occur on the surface of the crystal.

In order to eliminate the difference in temperature distribution, it is necessary to increase thermal conductivity between the laser crystal 8 and the holder 6 and to efficiently transfer the heat of the laser crystal 8 to the holder 6.

In the conventional type structure for holding the laser crystal 8, the laser crystal 8 is sandwiched between the holder 6 and the crystal holding piece 11. The lower surface of the laser crystal 8 is pressed against the bottom surface of the holding groove 9, and the upper surface of the laser crystal 8 is pushed toward the lower surface of the convex portion 11a. Because the laser crystal 8 is engaged into the holding groove 9, both side surfaces of the laser crystal 8 are not necessarily fit to both groove walls of the holding groove 9 tightly.

Further, as shown in FIG. 7, in the laser crystal 8, there is not necessarily parallel relationship between an upper surface and a lower surface or between a left surface and a right surface. Also, in the holding groove 9, there is not necessarily parallel relationship between both groove walls. In addition, on the surface of both machined groove walls, there may remain surface roughness which occurred during the machining. It cannot be definitely said that the bottom surface of the holding groove 9 is closely fit to the lower surface of the laser crystal 8, or the lower surface of the crystal holding piece 11 is tightly fit to the upper surface of the laser crystal 8. For this reason, thermal conductivity between the laser crystal 8 and the holder 6 or the crystal holding piece 11 is decreased, and this leads to the reduction of the cooling efficiency of the laser crystal 8.

For the purpose of increasing thermal conductivity between the holder 6 and the laser crystal 8, a method is known, in which gold is deposited by evaporation on the surface of the laser crystal 8 to decrease heat resistance on the contact surface. However, it is impossible to compensate the decrease of adhesion (close fitting) when there is no parallelism or the decrease of adhesion caused by the surface roughness. For this reason, it has been necessary to change the structure itself for holding the laser crystal 8 in order to achieve furhter high-output operation.

### SUMMARY OF THE INVENTION

It is an object of the present invention to provide a semiconductor laser device, by which it is possible to increase cooling efficiency of a laser crystal using a simple holding structure and to accomplish high-output operation in the semiconductor laser device.

To attain the above object, semiconductor laser device according to the present invention comprises a laser crystal, a holder for holding the laser crystal, and a filling material with a low melting point interposed between the laser crystal and the holder. Also, the present invention provides the semiconductor laser device as described above, wherein there is further provided a crystal holding piece, a V-groove is formed on the holder, a V-groove is formed on the crystal holding piece, the laser crystal is engaged in the two V-grooves and is sandwiched between the holder and the crystal holding piece, and at least one of the holder or the crystal holding piece also serves as a heat sink. Further, the present invention provides the semiconductor laser device as described above, wherein an escape groove is provided on a surface where the laser crystal is held. Also, the present invention provides the semiconductor laser device as described above, wherein the crystal holding piece is pressed against the laser crystal via a spring. Further, the present invention provides the semiconductor laser device as described above, wherein the filling material is made of a metal, which is soft and has lower hardness than that of the laser crystal and the holder. Also, the present invention provides the semiconductor laser device as described above, wherein the filling material is plated on a surface of the laser crystal held by the holder.

The present invention also provides a method for holding a laser crystal in a semiconductor laser device, the method comprises the step of holding a laser crystal via a filling material with a low melting point, the step of heating in such manner that a temperature of the filling material will be a temperature near the melting point of the filling material, and the step of pressing and fixing the laser crystal to the filling material.

### BRIEF DESCRIPTION OF THE DRAWINGS

FIG. 1 is a perspective view showing an essential portion of an embodiment of the present invention;

FIG. 2 is a front view of the essential portion of the embodiment of the present invention;

FIG. 3 is a side view of the essential portion of the embodiment of the present invention;

FIG. 4 is a sectional side view of a conventional example;

FIG. 5 is a perspective view of a laser crystal holder of the conventional example;

FIG. 6 is a schematical drawing to show thermal distribution and thermal migration in the laser crystal holder of the conventional example; and

FIG. 7 is a drawing to explain conditions of a contact surface of the laser crystal and the holder in the conventional example.

### DETAILED DESCRIPTION OF THE PREFERRED EMBODIMENT

Description will be given below on an embodiment of the present invention referring to the drawings.

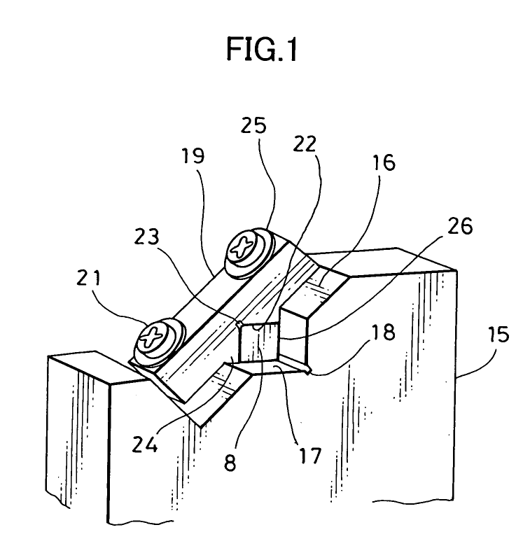

FIG. 1 to FIG. 3 each represents a laser crystal holder in a semiconductor laser device.

In FIG. 1, an inclined surface 16 with an inclination angle of 45° is formed on a holder 15, and a V-groove 17 with a vertical angle of 90° is formed on the inclined surface 16. An escape groove 18 is provided at a vertex of the V-groove 17.

A crystal holding piece 19 stretching over the V-groove 17 is mounted on the inclined surface 16 by means of screws 21. On the crystal holding piece 19, a V-groove 22 with a vertical angle of 90° is formed, and an escape groove 23 is provided at a vertex of the V-groove 22. On both sides of the V-groove 22, a bank 24 with a vertical angle of 90° is formed, and the bank 24 can be engaged with the V-groove 17.

A laser crystal 8 is engaged with the V-groove 17 and the V-groove 22. The laser crystal 8 is sandwiched by the holder 15 and the crystal holding piece 19. The crystal holding piece 19 is fixed on the holder 15 by means of the screws 21. Between the crystal holding piece 19 and the screws 21, springs 25 such as a spring washer or a disc spring are interposed, and the spring 25 applies a predetermined pushing force between the laser crystal 8 and the V-groove 17 and between the laser crystal 8 and the V-groove 22. Each of four sides on both end surfaces of the laser crystal 8 has a chamfered portion 27.

When the laser crystal 8 is fixed by the crystal holding piece 19, a pushing force is applied on the laser crystal 8 in a diagonal direction of a cross-section, and four surfaces of the laser crystal 8 are equally pushed toward the V-groove 17 and the V-groove 22.

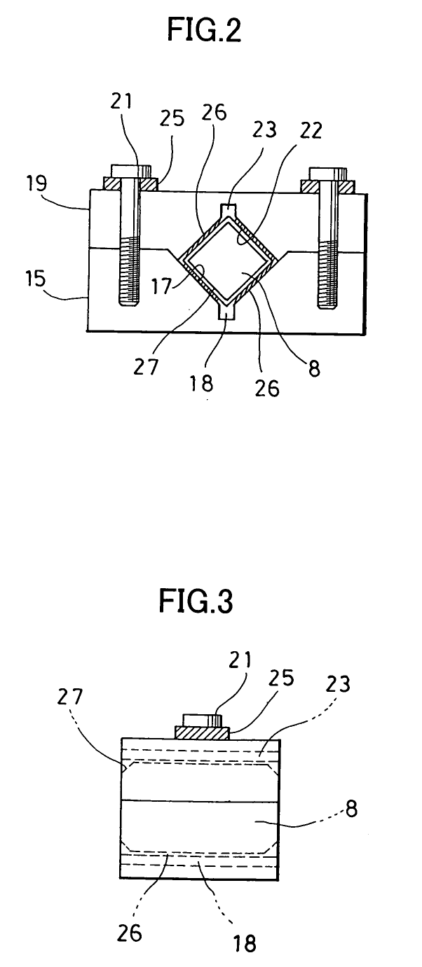

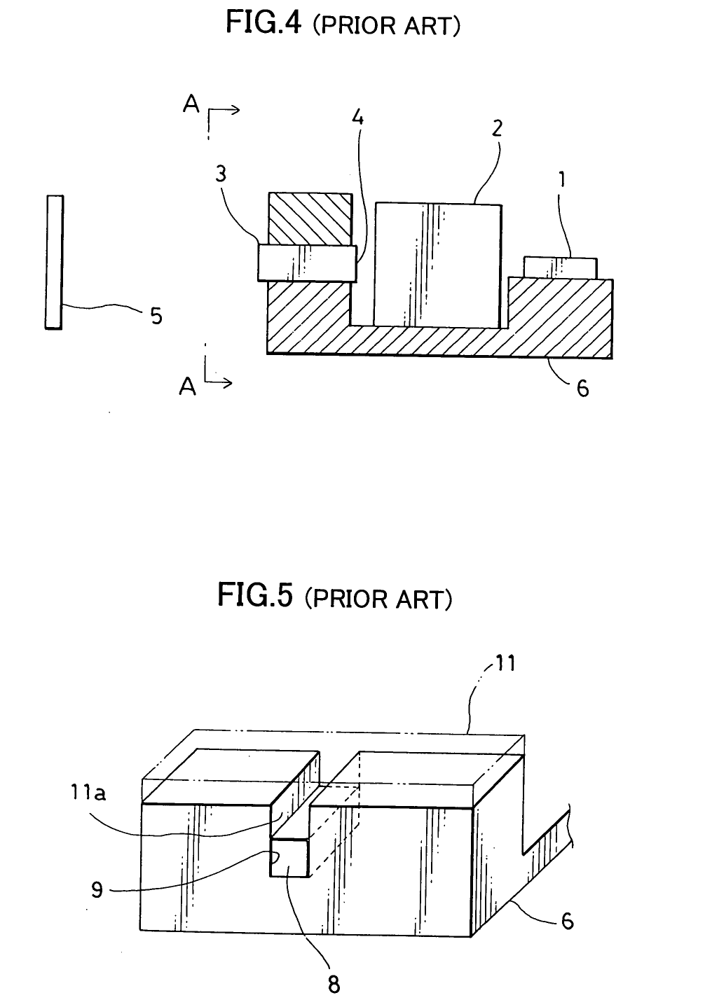

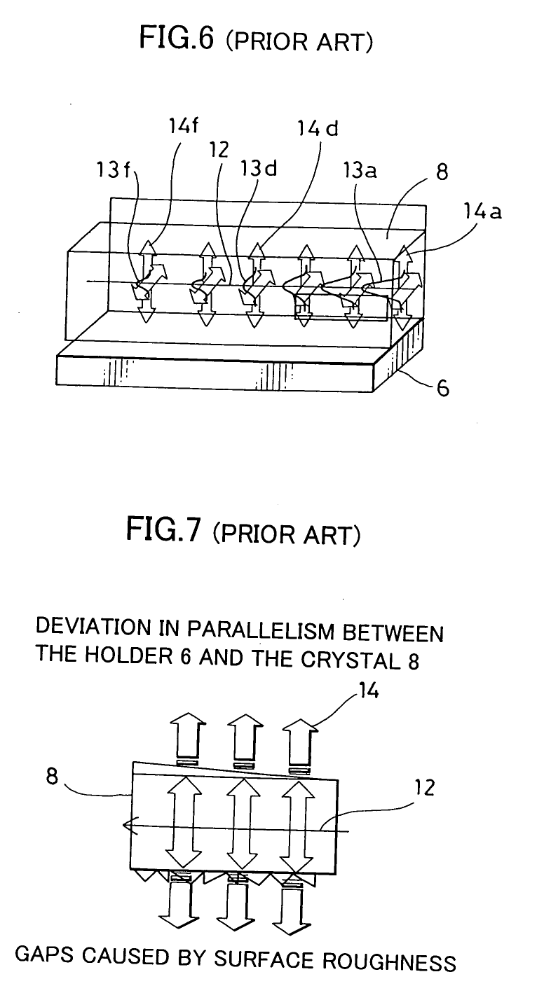

Now, further detailed description will be given by referring to FIG. 2 and FIG. 3. In each of FIG. 2 and FIG. 3, a holder of the laser crystal 8 is pick out and shown.

A filling material 26, which is soft and has lower hardness than the laser crystal 8 and the holder 15, are squeezed between the laser crystal 8 and the V-groove 17 and between the laser crystal 8 and the V-groove 22. The filling material 26 is made of a material, which is soft and has high thermal conductivity and a lower melting point. For instance, indium (In; melting point 156° C.) is used. As the material with a low melting point, In—Sn alloy (melting point 117° C.), Bi—Pb—Sn alloy (melting point 93° C.), etc. may be used. The melting point of the material with a low melting point should be lower than the temperature, at which an optical film formed by the laser crystal 8 is damaged.

A thickness of the filling material 26 should be higher than surface roughness of a fabricated surface of the V-groove 17 and the V-groove 22 or should be higher than an error of parallelism between the laser crystal 8 and the V-groove 17 or between the laser crystal 8 and the V-groove 22. For instance, the thickness is set to about 10 μm. The thickness of the filling material 26 is determined by giving full consideration on machining accuracy, etc. of the V-groove 17 and the V-groove 22. In case the thickness as described above is not much needed, the filling material 26 may be directly plated on four surfaces where the laser crystal 8 is squeezed.

Next, description will be given on operation when the laser crystal 8 is fixed.

Under the condition that the filling material 26 is interposed between the crystal holding piece 19 and the laser crystal 8 and between the holder 15 and the laser crystal 8, the laser crystal 8 is temporarily fixed. Then, the holder 15, the crystal holding piece 19, and the laser crystal 8 are heated up to a temperature near or slightly higher than the melting point of the filling material 26.

Next, the screws 21 are tightened so that a pushing force applied on the laser crystal 8 will be as high as a predetermined value. As the screw 21 is tightened, the filling material 26 is pressed and squashed. The filling material 26 is moved toward the regions with gaps, and fills micro-size gaps between the laser crystal 8 and the V-groove 17 and between the laser crystal 8 and the V-groove 22.

In this case, excessive part of the filling material 26 is forced into the escape groove 18 and the escape groove 23. Because the end surfaces of the laser crystal 8 are chamfered, the filling material 26 is not directed toward an incident end surface or an exit end surface of the laser crystal 8 even when the filling material 26 is forced and pushed toward the end surfaces. Thus, the filling material 26 is not deposited by a dirt at the both end surfaces of the laser crystal 8.

Because the filling material 26 fills micro-size gaps between the laser crystal 8 and the V-groove 17 and between the laser crystal 8 and the V-groove 22, contact area between the laser crystal 8 and the holder 15 and between the laser crystal 8 and the crystal holding piece 19 is increased. This contributes to the increase of thermal conductivity between the laser crystal 8 and the holder 15 and between the laser crystal 8 and the crystal holding piece 19. Of the holder 15 and the crystal holding piece 19, at least the holder 15 plays a role as an effective heat sink. In particular, when the holder 15 is provided with a cooling device such as a Peltier element, cooling effect is promoted.

Thus, the cooling effect of the laser crystal 8 is improved, and temperature increase of the laser crystal 8 is suppressed. Also, the difference in temperature distribution within the laser crystal 8 is decreased. This makes it possible to enter an excitation light of high output and to achieve high-output operation of the semiconductor laser device.

Because temperature change of the laser crystal 8 is quickly reflected in the holder 15, the temperature of the laser crystal 8 detected via the holder 15 can be measured accurately. This facilitates temperature control of the laser crystal 8 and is helpful to achieve higher accuracy of the temperature control.

In the operation to fix the laser crystal 8, it may be designed in such manner that the screws 21 are tightened in advance so that a predetermined pushing force is generated, and then, the holder 15, the laser crystal 8, and the crystal holding piece 19 may be heated up.

During the operation, in contrast to the time of shutdown, the temperature of the laser crystal 8 is increased, and the laser crystal 8 is subjected to thermal expansion. Because the crystal holding piece 19 is tightened via the springs 25, the thermal expansion of the laser crystal 8 is absorbed by displacement of the springs 25.

The present invention provides a semiconductor laser device, which comprises a laser crystal, a holder for holding the laser crystal, and a filling material with a low melting point interposed between the laser crystal and the holder. When heating is performed during the fixation of the laser crystal, the filling material fills micro-size gaps. This results in the improvement of thermal conductivity between the laser crystal and the holder. Cooling effect of the laser crystal is improved, and this contributes to high-output operation of the semiconductor laser device.

What is claimed is:

1. A semiconductor laser device, comprising a laser crystal, a holder for holding said laser crystal, and a filling material with a low melting point interposed between said laser crystal and said holder.

2. A semiconductor laser device according to claim 1, wherein there is further provided a crystal holding piece, a V-groove is formed on said holder, a V-groove is formed on said crystal holding piece, said laser crystal is engaged in the two V-grooves and is sandwiched between said holder and said crystal holding piece, and at least one of said holder or said crystal holding piece also serves as a heat sink.

3. A semiconductor laser device according to claim 1, wherein an escape groove is provided on a surface where said laser crystal is held.

4. A semiconductor laser device according to claim 2, wherein said crystal holding piece is pressed against said laser crystal via a spring.

5. A semiconductor laser device according to claim 1, wherein said filling material is made of a metal, which is soft and has lower hardness than that of said laser crystal and said holder.

6. A semiconductor laser device according to claim 1, wherein said filling material is plated on a surface of said laser crystal held by said holder.

7. A method for holding a laser crystal in a semiconductor laser device, said method comprising the step of holding a laser crystal via a filling material with a low melting point, the step of heating in such manner that a temperature of the filling material will be a temperature near the melting point of the filling material, and the step of pressing and fixing the laser crystal to the filling material.
